(19) United States
(12) Patent Application Publication
(10) Pub. No.: US 2004/0109733 A1
(43) Pub. Date: Jun. 10, 2004

(54) Cutting insert including a bracing layer

(75) Inventor: Richard Fouquer, Saint Cyr-Sur-Loire (FR)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: SAFETY-FABRIQUE DE CARBURE DE TUNGSTENE ET D'OUTILLAGE, BOULOGNE BILLANCOURT (FR)

(21) Appl. No.: 10/724,171

(22) Filed: Dec. 1, 2003

(30) Foreign Application Priority Data
Dec. 2, 2002 (FR) 02 15122

(51) Int. Cl. B23C 5/20

(52) U.S. Cl. 407/113

(57) ABSTRACT

1. The thread cutting insert (10) includes a laterally projecting tooth (30) comprising a front, chip cutting and repelling face (31), delimited by a cutting edge (31A) separating it from a flank area with a profile (33) having a determined overall relief angle (D), characterised by the fact that the tooth comprises, rearwards of a forward volume part (30A) directly supporting the cutting edge (31A) and limited by the flank area extending over a limited thickness (h1), a part (30B) for bracing the forward volume part (30A), having a profile (36) with an average relief angle differing from the overall relief angle (D) of the profile (33) of the flank area.

### FIELD OF THE INVENTION

The present invention relates to cutting inserts intended for cutting threads, whether internal or external.

### DESCRIPTION OF RELATED ART

Such a cutting insert has a frontal face moving substantially perpendicularly to the surface to be cut, in order to rake it, with, in addition, an axial feed translation motion, with one or more laterally extending teeth forming a sort of groove-cutting rake. The chips are cut by a cutting edge with a generally V or U-shaped front profile delimiting a ground front face of the tooth against which the chips slide. The cutting edge is bordered by the flanks of the tooth which conventionally have, over the entire thickness of the insert, a controlled surface finish quality, obtained by careful grinding or casting, with a determined relief angle, whether positive or negative, to avoid any unwanted rubbing of the heel, rearwards of the tooth, on the internal or external thread, respectively.

The insert, which is fixed by a central screw to a tool support, must be sufficiently thick to withstand, without excessive deformation, the bending moment corresponding to the peripheral chip-cutting force. In particular, the tooth must be thick enough to withstand the localized stress of chip cutting without premature spalling. Conventionally, the thickness of the insert is at least 3 millimetres and it can be as much as approximately 6 millimetres.

However, this thickness must not increased too much as the insert would be unusable for tapping holes of a limited diameter, owing to the contact between the heel of the tooth and the edge of the orifice machined. It would be conceivable to increase the relief angle, i.e. to reduce the wedge angle of the lateral profile of the cutting edge, but the latter would become too fragile and would run the risk of chipping, or nicking, owing to the increased overhang, that is to say if the back part of the tooth provided only insufficient bracing.

In the case of an application for external thread cutting, the relief angle can, of course, be practically nil and the thickness can be relatively great, but the cutting edge remains sensitive to the localised external stresses present in this area such as, for example, vibrations.

Furthermore, when the insert is manufactured, production of the desired quality of the tooth flanks is a costly matter.

The present invention aims to provide a solution intended to treat at least one of the problems mentioned above, i.e. mechanical stress resistance, overall thickness and manufacturing cost, in order to at least attenuate the corresponding drawbacks.

### SUMMARY OF THE INVENTION

For this purpose, the invention provides a thread cutting insert including a laterally projecting tooth comprising a front, chip cutting and repelling face, delimited by a cutting edge separating it from a flank area with a profile having a determined overall relief angle, characterised by the fact that the tooth comprises, rearwards of a forward volume part directly supporting the cutting edge and limited by the flank area extending over a limited thickness, a part serving to brace the forward volume part, having a profile with an average relief angle differing from the overall relief angle of the profile of the flank area.

Thus, the tooth functionally comprises two stacked layers that cooperate in order to support the cutting edge, since the bracing part forms a pedestal making its contribution, in order to support the cutting edge, through the forward part.

As the forward part, or frontal layer, has a limited thickness which is less than the total thickness of the insert, it is easy to provide for the relief angle of the front part to be restricted to a small value, or even for it to be nil, that is to say to provide for a maximum wedge angle, there thus being a maximal mass of material behind the front face.

In the case of thread tapping, the risk of unwanted rubbing of the heel of the bracing part on the surface of a bore of limited diameter can be avoided since this heel can, thanks to an increased angle of “positive” relief of the bracing part, remain standing back and within the circle representing the cross-section of the bore. The overhang of the cutting edge can thus be restricted since its extent is proportional to the relief angle and to the thickness of the forward part. The front face of the tooth is thus braced substantially perpendicularly by the material of the forward part, located practically behind all of the cutting front face. As the overhang is restricted, the thickness of the forward part of the tooth, even when limited, is, as it is, able to locally ensure satisfactory support for the cutting edge, without the help of the bracing pedestal layer.

In the case of external thread cutting, the average relief angle of the bracing part can be chosen to be negative, that is to say that the bracing part can take the form of a rostrum, or spur, designed to substantially mate with the curvature of the work-piece.

In such a case, the bracing part can have an average relief angle that is less than the overall relief angle of the flank area.

In particular, in this case, the average relief angle of the bracing part is preferably negative so that the bracing part forms the spur, designed to substantially mate with the curvature of a piece having a cylindrical outer surface on which a thread is be cut, with the spur extending laterally, towards the piece for thread cutting, further than a point of junction between the flank area of the forward part and a corresponding flank area having said profile of the bracing part.

Preferably, the spur extends laterally towards the piece for thread cutting, further than the cutting edge.

In both cases, internal or external thread cutting, the bracing part thus ensures additional resistance to mechanical stresses, with its mass being added to that of the rest of the tooth to thus increase the inertia of the tooth, hence reduce the amplitude of local vibrations and, in particular, increase the bending resistance of the tooth to the pressure force exerted by the chips pressed against the front face.

Briefly, the active forward part of the tooth is rooted in a single piece, laterally, in the forward layer of the insert, which gives it a bending strength couple and it is rooted, thickness-wise, in the bracing layer, which gives it a counter-bearing force biasing it forwards.

The manufacturing cost of the insert can thus be restricted since the controlled quality of the flank surface applies only to a limited thickness.

As to thread tapping, the bracing part stands back laterally, in relation to the forward volume part, corresponding to an average relief angle which is greater than the overall relief angle of the flank area.

In one form of embodiment of interest, the profile of the bracing part corresponds to a determined geometrical curve that connects directly to a back end of the profile of the flank area.

In another form of embodiment of interest, the profile of the bracing part connects, at a back end of the profile of the flank area, by a section of curve with a relief angle with a set-back, having an average relief angle representing an extreme value, in relation to the remainder of the profile of the bracing part, said remainder having a relief angle of the same sign as the extreme value, or the opposite sign, for an extreme set-back value of the profile, followed by an advance in the form of a spur.

In such a case, said remainder of the profile of the bracing part can have an average relief angle that is greater than, equal to, or even smaller than the overall relief angle of the flank area, since the set-back makes it possible to ensure the desired clearance of the heel in relation to the work-piece.

The section of curve with a relief angle with a set-back preferably has a set-back with a lateral extension of between 1 and 50% of a lateral height value of the tooth. The profile of the flank area can, for example, be either straight or curvilinear.

In one preferred form of embodiment, the forward volume part of the tooth has a thickness of between 10 and 50% of a thickness value of the insert.

When the flank area has different surfaces extending substantially in respective planes inclined at different bevel angles in relation to a direction of penetration perpendicular to a surface of the work-piece, the relief angle of the flank area can follow an increasing law as a function of the bevel angle, representing, for example, substantially the sine of the bevel angle. The angle can comprise a minimum threshold constant, representing a minimum clearance value.

The profile of the bracing part can correspond, according to a determined law of resistance to rearward bending due to cutting, to a smooth curve of moment of inertia in as to bending, as a function of a current height position in the tooth, with the smooth curve having discontinuities, or breaks, of slope limited to an upper threshold value.

Localised stress due to bending forces and vibrations is thus limited.

The bracing part is advantageously connected, at a back end of the profile of the flank area, by a section of curve with a relief angle and with a set-back, having an S-shaped profile, with ends substantially aligned with said back end and the rest of the profile of the bracing part, respectively.

The absence of an angular point in the overall profile thus limits the breaks of slope of the moment of inertia.

The tooth can, in particular, laterally present a determined bevel angle for widening starting from a beak tip edge, and the bracing part of the tooth comprises two flanks with a relief angle that is variable according to a law of growth varying in the same direction as said widening, and designed to smooth said curve, of moment of inertia, by, at least partial, compensation for said widening. The forward volume part of the tooth can further have a thickness that is variable according to a smoothing law designed to compensate, at least partially, for variations in the moment of inertia due to said widening and to the variable relief angle of the two flanks of the bracing part.

### BRIEF DESCRIPTION OF THE DRAWINGS

The invention will be more readily understood with the help of the following detailed description of two examples of forms of embodiment of interest of the insert according to the invention, usable in these two examples for external or internal thread cutting, with reference to the annexed drawings, wherein:

FIG. 1 is a partial view of a cross-section of a bore during internal thread cutting using a thread cutting insert according to the first form of embodiment of the invention;

FIG. 2 is a perspective view of the insert of FIG. 1;

FIG. 3 is an enlarged view of the area surrounded by a circle in FIG. 1, showing a tooth of the insert, of a determined lateral profile;

FIG. 4 is equivalent to FIG. 3 and corresponds to the second form of embodiment, for a tooth having another lateral profile; and

FIG. 5 shows a curve presenting the changes in the moment of inertia of the insert.

### DESCRIPTION OF PREFERRED EMBODIMENTS

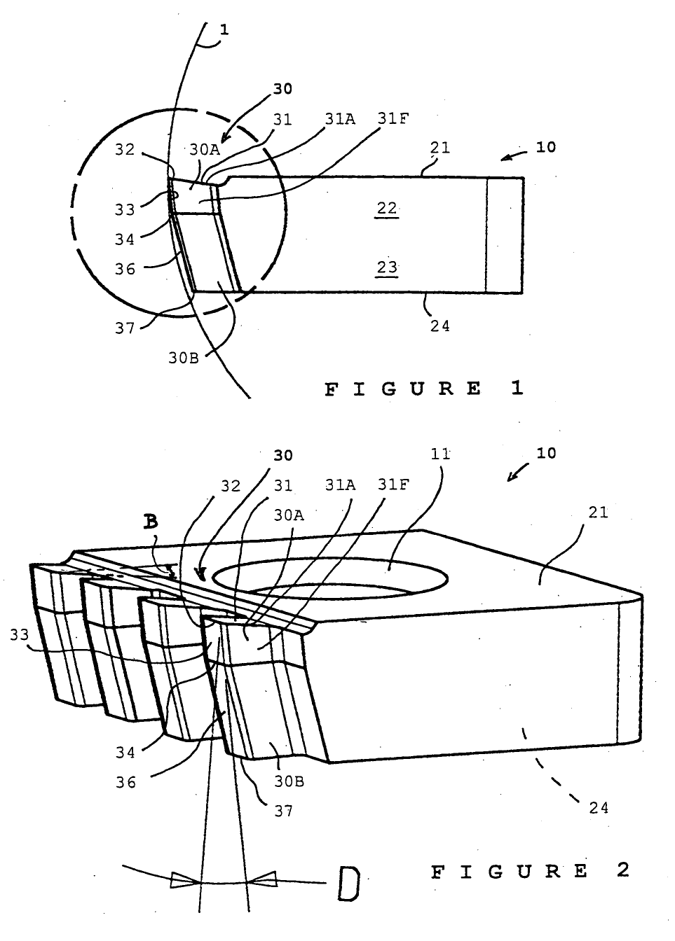

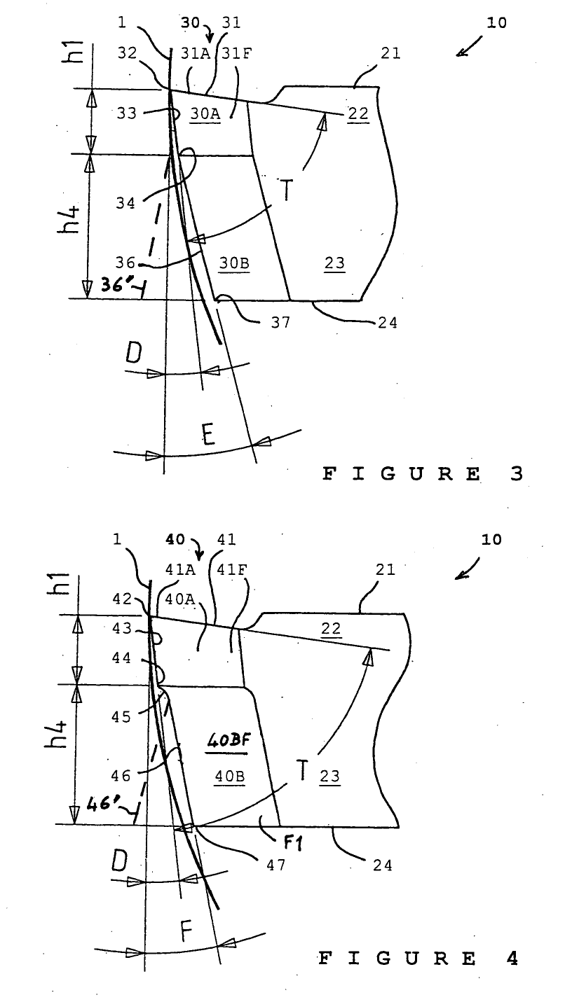

FIGS. 1, 3 and 2 show, respectively, in cross-section and in perspective, an insert 10 in position for tapping a circular orifice 1 of a work-piece. Insert 10 is pierced here by a hole 11, here vertical, for receiving a screw for removable attachment to a tool holder, not shown.

Insert 10 has here substantially the shape of a rectangular parallelepiped, with a front face or surface 21 and a back face or surface 24. For the sake of simplicity, faces 21 and 24 are supposed here to be horizontal. One of four lateral, horizontally extending teeth seen in FIG. 2 bears reference number 30 in FIGS. 1 to 3. Tooth 30 has a determined cutting height represented by its lateral extension, projecting from a virtual reference plane, substantially vertical in the figures, tangent to the valleys separating the teeth. Tooth 30 comprises a front face, or cutting face, 31 forming part of front face 21, but which has been ground so as to hollow it out slightly obliquely towards the centre of front face 21 in order to facilitate sliding of the chips in this direction.

As shown in FIG. 2, cutting face 31 is limited by a cutting edge 31A, here substantially in the shape of a beak with a frontal profile that is generally of a V shape and, precisely here, a U shape, the base of which is a beak end edge or tip 32 pointing slightly forwards (FIG. 1) in relation to front face 21, as mentioned above. Cutting face 31 frontally limits a forward volume part 30A of tooth 30, laterally limited by a flank area or edge with a surface having a determined finish quality, obtained here by grinding, constituted by the prolongation of cutting edge 31A towards rear face 24. The ground flank area is constituted by flanks 31F of the U shape, including its bottom flank 33, which forms a summital edge surface of forward part 30A, rearwardly prolonging beak end edge 32 by forming a tail which thus starts from beak tip edge 32 and extends to a rear end 34 over a length corresponding to a limited thickness of tooth h1, here approximately one third of the total thickness of insert 10. In other preferred examples, summital edge 33 has a length h1 of between 10 and 50% of the total thickness of insert 10.

Summit edge 33 has a relief angle D of forward part 30A of tooth 30 in relation to the direction, which is vertical here, of feed of insert 10 in relation to the work-piece, and beak tip edge 32, defined by cutting front face 31 and summital edge 33, thus has an addendum angle T with a slightly acute lateral profile. The two opposed flanks 31F of the U shape also have a relief angle, which can, however, be limited without any problem, since the risk of rubbing of the rear heel connected with the curvature of the orifice applies only to summital edge 33, extending in the plane of FIG. 1, transverse to the orifice. In this example, flanks 31F and root 33 of the U have been ground to form respective plane surfaces, so that the relief angle remains constant over the entire thickness of the lateral surface under consideration. Otherwise, it would be necessary to consider an overall, or mean, value for the relief angle.

The beak tip edge 32 thus has a lateral overhang, in relation the rear end 34 of summital edge 33, which is proportional to the tangent of “forward” relief angle D and to the length h1 of summital edge 33. Forward relief angle D is very small here in order to limit the overhang, and represents about five to six degrees.

Generally speaking, tooth 30, and more generally insert 10, is functionally divided into two stacked layers which are, however, in a single piece. Thus, reference 22 generally designates a forward layer or volume of insert 10, including forward part 30A of tooth 30, forward layer 22 being limited by a horizontal virtual plane, parallel to the plane of front face 21 and containing back end 34 of summital edge 33. Forward layer 22 thus has a thickness substantially equal to h1. Reference 23 designates the rest of insert 10, i.e. a rear layer forming a pedestal, having a thickness h4, for bracing forward part 30A of tooth 3, as well as the rest of forward layer 22.

Tooth 30 thus extends into rear layer 23, in the form of a rear part 30B, forming a counter-bearing root or pedestal, which generally has the U-shaped front profile of forward part 30A. However, rear part 30B is laterally set back in relation to a virtual prolongation of the line segment of summital edge 33, that is to say it generally has an average relief angle greater than forward relief angle D, so as to provide an increased clearance gap in relation to the work-piece so as to avoid any rubbing of a heel 37 of back face 24.

For this purpose, summital edge 33, the forward edge, continues, beyond its back end 34, towards back face 24, by a rear summital edge 36, which here generally takes the form of forward summital edge 33, that is to say a line segment, but with a “rear” relief angle E greater than forward relief angle D, and representing here about ten degrees. Heel 37 is determined by the back end of rear summital edge 36.

Alternatively, the overall profile of the two summital edges 33 and 36 can be considered as a portion of a circle, or rounded curve of the same type, with a ground forward section 33, straight or curved, with the heel (37) remaining clear of the surface of the orifice to be cut as long as the radius of the latter exceeds that of the circle portion. Preferably, forward summital edge 33 has a convex curvature to ensure optimum support of cutting edge 31A.

As mentioned initially, the forward relief angle D may be nil if, alternatively, the application relates to external thread cutting. In this case, as there is no risk of heel 37 rubbing, it is possible for rear part 30A to have only a very small rear relief angle E, that is to say it can ensure very efficient counter-bearing while not necessitating grinding since it stands back by more than a minimum clearance threshold.

In the case of thread cutting a cylinder of a determined diameter, the rear part 30B would have a profile with an advancing, or “negative”, overall relief angle. This can be, for example, an arc of circle parallel to the surface machined in order to surround it with a minimum clearance, that is to say with a heel 37 laterally projecting beyond point of junction 34 of the two summital edges 33, 36, or even beak tip edge 32.

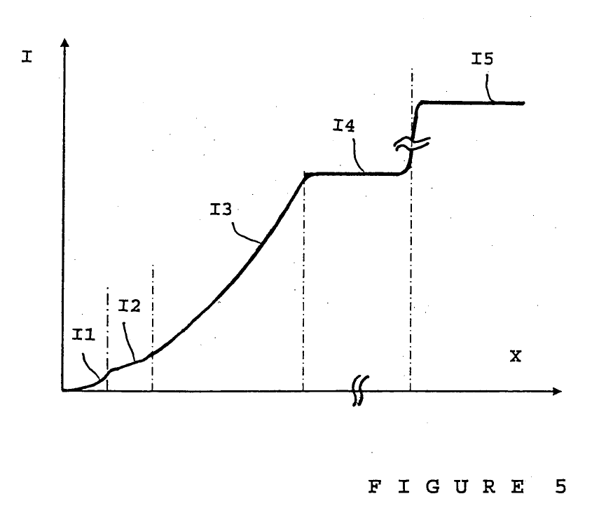

FIG. 4, which illustrates the variant, comprises elements 21, 24, 40, 40A, 40B, 41A, 41F, 41, 42, 43, 44, 46 and 47, which correspond to the equivalent elements in FIG. 2, with the units of the reference numbers remaining the same but with “4” replacing “3” in the tens, as applicable. Consequently, the explanation that follows relates only to one new element, which is a short section 45 of rear summital edge intended to connect back end 44, of forward summital edge 43 of forward part 40A, to rear summital edge section 46 of rear part 40B, forming a pedestal. Connecting section 45, which is here concave, generally has a relief angle greater than a relief angle F of rear summital edge section 46, which is, itself, greater than forward relief angle D.

Rear summital edge section 46 is thus “quickly” set back from the work-piece on proceeding from forward summital edge 33 to rear summital edge section 46. Thanks to this “initial” margin of clearance in relation to the work-piece, relief angle F could, alternatively, be equal to, or even less than, forward relief angle D, insofar as the relief angle defined by ends 44 and 47 of rear summital edge 45, 46 remains greater than forward relief angle D.

The curve section 45 having a relief angle with a set-back here has a lateral extension of approximately 5% of the lateral height value of cutting front face 41, which extension, in other cases, is preferably of between 1 and 50% of the height of tooth 40.

The same type of profile, having a discontinuity or break of slope 45, is to be found at the back end connecting each of the two flanks 41F of the U shape of the forward part 40A with two respective flanks of a U shape of the rear part 40B, that is to say the type of profile shown in FIG. 4 would still be applicable if the vertical plane of cutting of tooth 40 were to be rotated about a vertical. As mentioned earlier, discontinuity 45 can, however, be gradually reduced in proportion to movement away from a plane of cross-sectional representation, passing via summital edge 43, as in FIG. 4, and perpendicularly to the machined surface of the work-piece.

Penetration of the work-piece is, in fact, maximum for the beak tip edge 42, which is moved to the left, hence perpendicularly to its direction of extension, horizontal and parallel to the vertical plane of the surface machined, and further perpendicular to the plane of FIG. 4. On the other hand, flanks 41F, or the legs of the U, are turned back, by an angle which is here as much as almost 90 degrees, for example approximately 85 degrees here, in globally a plane of direction oblique in relation to the direction of extension of the beak tip edge 42, hence also in relation to the surface to be machined. Flanks 41F thus have a penetration machining component that is reduced according to the cosine of the turn-back angle, of approximately 85 degrees. Penetration thickness is thus similarly reduced, which makes it possible to have a smaller relief angle, reduced as a function of the turn-back angle, and, for example, varying substantially like the cosine of the turn-back angle.

In other words, and taking as a reference the normal direction of machining (horizontal in FIG. 4), and not the direction of extension of the beak tip edge 42 (perpendicular to the plane of FIG. 4), the flank area 43, 43F has different surfaces, frontal and lateral, extending substantially in planes inclined at different bevel angles B (90d—turn-back angle), with, respectively, a bevel angle B of 90 degrees in the case of beak tip edge 42 and 5 degrees here in that of the two flanks 41F, in relation to the direction of penetration perpendicular to a surface of the work-piece. Relief angle D of the flank area 43, 43F increases by following a law which is a function of the bevel angle B in relation to the normal direction of machining. The law can then substantially represent the sine of the bevel angle B on the direction of machining. As a safety clearance, provision may be made for adding a constant minimum-threshold value to the value thus calculated, or just clipping it in terms of minimum value.

The above explanation concerning the variation in relief angle D also applies to the embodiment according to FIGS. 1 to 3.

In the above two examples, the lateral tooth profiles are rectilinear. Alternatively, as mentioned earlier, they can be of a different shape, for example curvilinear, or even circular, with profile 36, 46 of the rear part 30B, 40B standing back in relation to the virtual prolongation, of forward summital edge 33, 43, defined by a geometrical law defining the lateral profile under consideration. The forward offset angle D or rear offset angle E to be considered is then the average, or overall, relief angle.

In the case of external thread cutting, the lateral profiles of rear parts 30B and 40B would be located in a position substantially symmetrical in relation to the plane, which is vertical in the figures, containing junction point 34, 44, that is to say heel 37, 47 would form a spur, with a negative relief angle E, F, extending laterally beyond junction point 34, 44, and, preferably, beyond beak tip edge 32, 42. Dashed lines 36′, 46′ thus represent the position of the spur variant of profile 36, 46 that has rotated by a certain angle about its connection with curved section 33, 45. If applicable, profile 33, 43 of forward part 30A, 40A can also have a relief angle D that is nil, or even negative.

Insert 10 and, in particular, tooth 40 constitutes, from a mechanical viewpoint, a beam having a lateral profile, in vertical cross-section in FIG. 4, such that its moment of inertia I, that is to say the moment I or couple of bending strength materialised by the downward recoil of cutting edge 41A during cutting, increases in quadratic fashion as a function of the thickness in question. Current thickness can thus be specified as a function of a variable which, in FIG. 5, is the distance X between a current point and a reference point which is beak tip edge 42, when going towards the base of tooth 40, that is to say substantially towards hole 11, hence to the right along a horizontal in the plane of FIG. 4.

Depending on the distance X between beak tip edge 42 and a current cross-section, of tooth 40, for which the moment of inertia I is considered, the current moment of inertia I, local in the section under consideration, first has a first segment I1 increasing according to a first, quadratic, law, over a first range of horizontal movement ending perpendicularly to back end 44 of forward summital edge 43.

Then, perpendicularly to intermediate connecting section 45, which is curved here, moment of inertia I has a second segment I2, which is intermediate, with a second law for which growth initially continues in a more limited manner, owing to the fact that the beginning of curve 45, close to connecting point 44, has a slope, of increase of thickness of insert 10, that is less than the slope of rear summital edge 43, in relation to the direction of the plane of the section under consideration, that is to say a vertical in FIG. 4. In other words, the second segment 12 of curve remains short of a curve of extrapolation of first moment of inertia I curve segment I1.

A third segment 13 of the curve of moment of inertia I, perpendicularly to the range, corresponding to the rear rectilinear summital edge 46, presents additional growth according to a third law, that of quadratic growth. The third law corresponds substantially to the first law, with, however, on one hand, a shift of the value of the distance variable X, due to the presence of the set-back associated with the second segment I2 and, on the other hand, a weighting (90d—F) of quadratic growth, which is smaller, since rear relief angle F is greater, here, than forward relief angle D. The beginning of the third segment I3 is in the prolongation of the end of the second segment as intermediate section 45 has an end section aligned with rear edge 46.

After heel 47, a fourth segment I4 of the curve of moment of inertia I corresponds to a horizontal, i.e. a moment of inertia I remaining constant.

On passing via the valleys separating the teeth, the current cross-section thus penetrates the solid body of insert 10 and a fifth segment I5 of the inertia curve then presents a sharp step rising to a constant level associated with the thickness of insert 10.

The shapes of the curves of moment of inertia I above are, in fact, “basic curves”, corresponding to an imaginary slice of metal of tooth 40 cut parallel to the plane of FIG. 4, that is to say having a constant width (or slice thickness), this width being measured perpendicularly to the plane of FIG. 4. In the present case, the width of tooth 40, perpendicularly to the plane of FIG. 4, varies according to three parameters.

The first parameter is the angle of inclination of each leg of the U, formed by flanks 41F, in relation to the direction of extension of beak tip edge 42, which is itself parallel to the surface of the work-piece. As mentioned earlier, cutting edge 41A has, in top, face, view, the legs of a U-shape which rise, diverging slightly, that is to say they are each turned back at an angle of 85 degrees, for example, in relation to beak edge 42 at the bottom of the U. This first parameter, of widening of tooth 40, thus tends to increase the moment of inertia as to bending, in proportion to this widening.

The second parameter is the relief angle of flanks 41F which, going down along the thickness of tooth 41A towards the plane of back face 24, reduces the width of tooth 40 in relation to the width of cutting edge 41A. This second parameter thus tends to reduce moment of inertia I.

The third parameter is the thickness of forward part 40A as a function of the variable, that is to say the distance X to beak tip edge 42, although this thickness is drawn here as being of a constant value.

Steps can then be taken to adjust these three parameters mutually so that moment of inertia I varies only smoothly, or even remains substantially constant, in order to avoid breaks of slope in its curve, liable to correspond to positions of cross-sections subjected to shearing stresses that are higher than elsewhere and thus leading to a risk of accelerated deterioration, in particular with the vibrations associated with machining.

For this purpose, to avoid or limit the acuteness of any point of connection angle between the segments, connecting section 45 can then be modified to have a rectilinear profile, or a cambered one, or, better still, an S-shaped profile. In the last case, connecting section 45 comprises a convex forward part with a forward end section extending substantially in the direction of forward edge 43, to which it is connected, and comprises a concave rear end part, as drawn, extending substantially in the direction of associated rear edge 46. There is thus no discontinuity in the evolution of the value of moment of inertia I at each end of the second curve segment I2. Furthermore, the S-shape can be designed so that, between the two end parts above, moment of inertia curve I2 is substantially rectilinear, thus even further limiting any risk of localised stress.

As to the growth of inertia curve third segment I3, perpendicularly to rear edge 46, the diverging of the legs of the U-shape of tooth 40 and the relief angle of flanks 41F have, as indicated, effects, which are positive and negative, respectively, on the variation of tooth width, which effects are reflected substantially linearly in this growth. By adjusting the third parameter, that is to say the current thickness of forward part 40A as a function of the distance X to beak tip edge 42, it is possible to smooth the curve of moment of inertia I. The current thickness that is suitable for forward part 40A, as a function of the desired value for moment of inertia I, is determined using an inverse transform of the aforementioned quadratic law.

For example, if the relief angle of flanks 41 remains constant over the entire height (horizontal in FIG. 4) of tooth 40, the width of tooth 40 will thus grow linearly, in relation to the above-mentioned “basic” curve, going to the right, towards the valley of tooth 40. Furthermore, the two flanks 40BF of part 40B, also standing back in relation to a plane prolonging forward flanks 41F, also have a relief angle F1, in particular in their area close to the rear edge 46 to be considered in connection with inertia curve third segment I3. Rear flanks 40B similarly contribute to the increase in inertia.

Fourth curve segment I4, corresponding to the base of tooth 40, similarly presents growth for the same reasons as for the third segment I3.

To increase the inertia determined by second segment I2 and the following segments, provision can be made for limiting the relief angle F1 of rear flanks 40BF to a value less than that of angle F of rear edge 46, just as described in connection with flanks 41F.

1. Thread cutting insert (10) including a laterally projecting tooth (30, 40) comprising a front, chip cutting and repelling face (31A, 41A), delimited by a cutting edge (31A, 41A) separating it from a flank area (33, 31F, 43, 41F) with a profile (33, 43) having a determined overall relief angle (D), characterised by the fact that the tooth comprises, rearwards of a forward volume part (30A, 40A) directly supporting the cutting edge (31A, 41A) and limited by the flank area (33, 31F, 43, 41F) extending over a limited thickness (h1), a part (30B, 40B) for bracing the forward volume part (30A, 40A), having a profile (36, 45, 46) with an average relief angle (E, F) differing from the overall relief angle (D) of the profile (33, 43) of the flank area (33, 31f, 43, 41F):

2. Insert according to claim 1, in which the profile of the bracing part (30B, 40B) corresponds to a determined geometrical curve (36) that connects directly to a back end (34) of the profile (33) of the flank area (33, 31F).

3. Insert according to claim 1, in which the profile (45, 46) of the bracing part (40B) connects, at a back end (44) of the profile (43) of the flank area (40, 41F), by a section of curve (45) with a relief angle with a set-back, having an average relief angle representing an extreme value, in relation to the remainder of the profile (46) of the bracing part (40B).

4. Insert according to claim 3, in which said remainder of the profile (46) of the bracing part (40B) has an average relief angle (E) that is smaller than the overall relief angle of the flank area (43).

5. Insert according to claim 3, in which the section of curve (45) with a relief angle with a set-back has a set-back with a lateral extension of between 1 and 50% of a lateral height value of the tooth (40).

6. Insert according to one of claims 1 to 5, in which the profile (33, 43) of the flank area (33, 31F, 43, 41F) is curvilinear.

7. Insert according to one of claims 1 to 6, in which the forward volume part (30A, 40A) has a thickness (h1) of between 10 and 50% of a thickness value of the insert.

8. Insert according to one of claims 1 to 7, in which the flank area (33, 31F, 43, 41F) having different surfaces extending substantially in respective planes inclined at different bevel angles (B) in relation to a direction of penetration perpendicular to a surface of the work-piece, the relief angle (D) of the flank area (33, 33F, 43, 43F) follows an increasing law as a function of the bevel angle (B).

9. Insert according to claim 8, in which the law of growth substantially represents the sine of the bevel angle (B).

10. Insert according to claim 8, in which the law comprises a minimum threshold constant.

11. Insert according to any one of claims 1 to 10, in which the profile (36, 45, 46) of the bracing part (30B, 40B) corresponds, according to a determined law of resistance to rearward bending due to cutting, to a smooth curve of moment of inertia as to bending (I), as a function of a current height position (X) in the tooth (30, 40), with the smooth curve having breaks of slope limited to an upper threshold value.

12. Insert according to claim 11, in which the bracing part (30B, 40B) is connected, at a back end (44) of the profile (43) of the flank area (40, 41F), by a section of curve with a relief angle and with a set-back (45), having an S-shaped profile, with ends substantially aligned with said back end (44) and the rest of the profile (46) of the bracing part (30B, 40B), respectively.

13. Insert according to claim 11, in which the tooth (30, 40) laterally presents a bevel angle (B) having a determined widening starting from a beak tip edge (32), and the bracing part (30B, 40B) of the tooth (30, 40) comprises two flanks (40BF) with a relief angle (F1) that is variable according to a law of growth varying in the same direction as said widening, and designed to smooth said curve, of moment of inertia (I), by, at least partial, compensation for said widening.

14. Insert according to claim 13, in which the forward volume part (30A, 40A) of the tooth (30, 40) has a thickness that is variable according to a smoothing law designed to compensate, at least partially, for variations in the moment of inertia (I) due to said widening and to the variable relief angle (F1) of the two flanks (40BF) of the bracing part (30B, 40B).

15. Insert according to one of claims 1 to 14, in which the bracing part (30B, 40B) stands back laterally, in relation to the forward volume part (30A, 40B), corresponding to an average relief angle which is greater than the overall relief angle (D) of the flank area (33, 31F, 43, 41F).

16. Insert according to one of claims 1 to 15, in which the bracing part (30B, 40B) has an average relief angle (E, F) that is less than the overall relief angle (D) of the flank area (33, 31F, 43, 41F).

17. Insert according to claim 16, in which the average relief angle (E, F) of the bracing part (30B, 40B) is negative so that the bracing part (30B, 40B) forms a spur (37, 47), designed to substantially mate with the curvature of a piece having a cylindrical outer surface on which a positive thread is be cut, with the spur (37, 47) extending laterally, towards the piece for positive thread cutting, further than a point of junction (34, 44) between the flank area (33, 31F, 43, 41F) of the forward part (30A, 40A) and a corresponding flank area having said profile (36, 45, 46) of the bracing part (30B, 40B).

18. Insert according to claim 17, in which the spur (37, 47) extends laterally, towards the piece for positive thread cutting, further than the cutting edge (31A, 32, 41A, 42).
